(19) United States
(12) Patent Application Publication
(10) Pub. No.: US 2020/0168134 A1
(43) Pub. Date: May 28, 2020

(54) Staggered Arcuate Interlocking Frame Adapted for Silicone Edge Graphics

(71) Applicant: Branden Storey, West Haven, UT (US)

(72) Inventor: Branden Storey, West Haven, UT (US)

(21) Appl. No.: 16/202,032

(22) Filed: Nov. 27, 2018

(51) Int. Cl. G09F 13/18

(52) U.S. Cl. CPC G09F 13/18; G09F 15/0031

(57) ABSTRACT

A modular interlocking frame system for silicone edge graphics having dual layer frames interconnecting with dowels. Preferably, each frame is made with multiple layers such that each arcuate frame member is interconnected with dowels to adjacent members.

### FIELD OF THE INVENTION

This invention relates to printed graphics and more particularly relates to silicone edge graphics mounted on frames of steel, acrylic, aluminum, silicone, wood and the like.

### BACKGROUND

### Description of the Related Art

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Custom tradeshow displays often incorporate printed graphics unique to particular brands which are meant to create a stylistic impression and improve brand repute and prominence in the minds of business, consumers and others visiting and seeing displays at tradeshows, in showrooms, conference rooms and other public areas. These displays include twist counters, kiosks, banners, televisions and silicone edge graphics (SEG), which are becoming more-and-more desirable in tradeshow environments.

Silicone edge graphics typically comprise high-resolution, high-contrast dye sublimated fabric graphics laminated, or sewn at the perimeter, with a thin silicone strip which is mounted on a frame made from aluminum, steel, wood or polymeric materials. In some embodiments, these SEGs are backlit to improve visibility and attract attention.

The manufacture of design of freestanding and mounted custom tradeshow displays and SEGs has become a large industry into which hundreds of millions of dollars flow annually. The manufacture of the frames used in SEGs is the largest cost which those ordering and making SEGs incur, and the most time consuming. Typically SEGs come in only limited shapes, such as rectangles or squares, and are manufactured much in the same manner as picture frames with hard edges meeting at hard angles, which frames are often of insufficient tensile durability to long last the compressive forces applied by the stretched graphics mounted on them and which quickly deteriorate and sag. SEGs with irregularly-shaped or arcuate frames are more desirable, but framing for these SEGs is also more time-consuming and expensive. These frames are often cut from polymeric sheets which are expensive and almost entire wasted to produce an arcuate frame.

In view of the foregoing, traditional SEG frames and framing methods are inadequate. An object of the present invention is to provide a novel arcuate frame which can be manufactured from a polymeric sheet while minimizing waste of the sheet, which withstands the forces applied during mounting and use of the SEGs, and which is reliable and easy to assemble and disassemble.

### SUMMARY

From the foregoing discussion, it should be apparent that a need exists for a dampening hinge system that suppresses periodic motions and abrasive wear on a hinge supporting an axial load. The present invention applies various components in novel ways to achieve this. In some embodiments, the connector arms for the hinge system may include bearings, smooth outer surfaces, and tight fittings to help suppress the periodic motions and abrasive wear. Additionally, adjustable mounting apertures provide flexibility during mounting, which reduces stress on the hinge system.

The present invention has been developed in response to the present state of the art, and in particular, in response to the problems and needs in the art that have not yet been fully solved by currently available apparatus. Accordingly, the present invention provides a interlocking frame for silicone edge graphics comprising: a lower frame comprising: a horizontal member having a planar bottom surface comprising two protuberances adapted to interlock with adjacent lower arcuate members, the horizontal member defining an outer channel for receiving a peripheral edge of a silicone edge graphic; a first arcuate member defining a recess on a concave surface adapted to interlock with an adjacent protuberance on the horizontal member, the first arcuate member comprising a protuberance cantilevering from a terminal end adapted to interlock with an arcuate keystone member; a second arcuate member defining a recess on a concave surface adapted to interlock with an adjacent protuberance on the horizontal member, the second arcuate member comprising a protuberance cantilevering from a terminal end adapted to interlock with an arcuate keystone member; a keystone arcuate member defining a recess on a terminal end adapted to interlock with an adjacent protuberance on one of the first arcuate member and the second arcuate member, the keystone arcuate member comprising a protuberance cantilevering from a terminal end adapted to interlock with an arcuate keystone member; wherein each of the first arcuate member, the second arcuate member and the keystone arcuate member define a pair of apertures extending longitudinally through from a top surface to a lower surface; a top frame comprising: a horizontal member having a planar bottom surface comprising two protuberances adapted to interlock with adjacent top arcuate members, the horizontal member defining an outer channel for receiving a peripheral edge of a silicone edge graphic; three or more arcuate members defining a recess on a terminal end adapted to interlock with an adjacent protuberance on an adjacent arcuate member, each arcuate member comprising a protuberance cantilevering from a terminal end adapted to interlock with an adjacent member of the top frame; wherein each of the top arcuate members define an aperture at a terminal end positioned to align with an aperture defined at an inferior midpoint on the lower frame.

The interlocking frame may further comprise a plurality of dowels adapted to insert into an aperture on top frame and the lower frame. The interlocking frame, in some embodiments, further comprises a plurality of light emitting diodes (LEDs) affixed to a top surface of the lower frame.

In other embodiments, the lower frame arcuate members each define an outer channel for receiving the SEG.

A second interlocking frame for silicone edge graphics is provided comprising: a lower frame comprising: a horizontal member having a planar bottom surface comprising two protuberances adapted to interlock with adjacent lower arcuate members, the horizontal member defining an outer channel for receiving a peripheral edge of a silicone edge graphic; a first arcuate member defining a recess on a concave surface adapted to interlock with an adjacent protuberance on the horizontal member, the first arcuate member comprising a protuberance cantilevering from a terminal end adapted to interlock with an arcuate keystone member; a second arcuate member defining a recess on a concave surface adapted to interlock with an adjacent protuberance on the horizontal member, the second arcuate member comprising a protuberance cantilevering from a terminal end adapted to interlock with an arcuate keystone member; a keystone arcuate member defining a recess on a terminal end adapted to interlock with an adjacent protuberance on one of the first arcuate member and the second arcuate member, the keystone arcuate member comprising a protuberance cantilevering from a terminal end adapted to interlock with an arcuate keystone member; wherein each of the first arcuate member, the second arcuate member and the keystone arcuate member define a pair of apertures extending longitudinally through from a top surface to a lower surface; a top frame comprising: a horizontal member having a planar bottom surface comprising two protuberances adapted to interlock with adjacent top arcuate members, the horizontal member defining an outer channel for receiving a peripheral edge of a silicone edge graphic; three or more arcuate members defining a recess on a terminal end adapted to interlock with an adjacent protuberance on an adjacent arcuate member, each arcuate member comprising a protuberance cantilevering from a terminal end adapted to interlock with an adjacent member of the top frame; wherein each of the top arcuate members define an aperture at a terminal end positioned to align with an aperture defined at an inferior midpoint on the lower frame; wherein the lower frame arcuate members each define an outer channel for receiving the SEG.

The interlocking frame may further comprise a plurality of dowels adapted to insert into an aperture on top frame and the lower frame.

The interlocking frame may further comprise a plurality of light emitting diodes (LEDs) affixed to a top surface of the lower frame.

Each member of the top frame and the lower frame may be formed via CNC.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a rearward perspective view of the top frame of a staggered arcuate frame adapted for silicone edge graphics in accordance with the present invention;

FIG. 2 illustrates a rearward, side perspective view of a staggered arcuate frame adapted for silicone edge graphics in accordance with the present invention;

FIG. 3 illustrates a top perspective view of a staggered arcuate frame adapted for silicone edge graphics in accordance with the present invention;

FIG. 4 illustrates a sectioned perspective view of a staggered arcuate frame adapted for silicone edge graphics in accordance with the present invention;

FIG. 5 illustrates a rearward, side perspective view of a staggered arcuate frame adapted for silicone edge graphics in accordance with the present invention;

FIG. 6 illustrates a forward perspective view of a staggered arcuate frame adapted with a silicone edge graphics in accordance with the present invention; and

FIG. 7 illustrates a forward perspective view of a staggered arcuate frame adapted with a silicone edge graphics in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The flow chart diagrams included herein are generally set forth as logical flow chart diagrams. As such, the depicted order and labeled steps are indicative of one embodiment of the presented method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

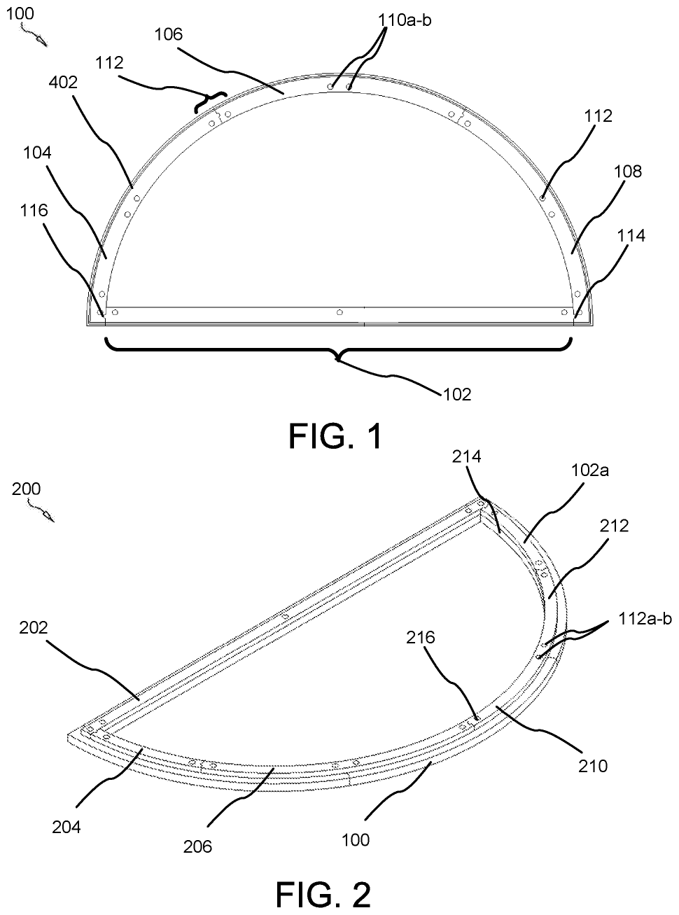

FIG. 1 illustrates a rearward perspective view of a top frame of a staggered arcuate frame 100 adapted for silicone edge graphics in accordance with the present invention. The arcuate frame 100 comprises a top frame having two lateral arcuate members 104, 108; a keystone member 106; and a planar member 102.

The horizontal member 102 in the shown embodiment comprises two protuberances 114 cantilevering laterally from the terminal ends of the horizontal member 102. These protuberances 114 interlock with matching recesses 116 on a concave inner surface of the lateral arcuate members 104. These recesses 116 contour the outer surfaces of the protuberances 114. The terminal ends of each member 102-108 may define an S-shaped surface which mates with a corresponding S-shaped surface on an adjacent component 102-108.

One terminal end of each arcuate member 104, 106, 108 comprises a protuberance 114 with the opposing terminal end defining a recess 116 for receiving a protuberance 114.

Each member 102-108 defines an outer channel 402 (further described below in relation to FIG. 4) recesses into a planar rearward surface of the member. The outer channels 402 of each member joint to form a track which circumscribes the entire rearward surface of the arcuate frame 100.

Each member 102-108 defines a plurality of apertures 110a-b which align with corresponding apertures on a top frame (show below in relation to FIG. 2 inter alia). Each aperture 110 receives a dowel 112 which passes through the aperture into a corresponding aperture on the lower frame.

Each member 104-108 defines a pair of apertures 110a-b centrally disposed at a midpoint on the arcuate member 104-108 such that the pair of apertures 110a-b straddles terminal ends of adjacent arcuate members on a top frame, wherein aperture 110a aligns with a corresponding aperture on a different superior arcuate member than aperture 110b.

Each member 102, 104, 106, 108 may be formed from sheets on a CNC machine, through injection molding, through additive manufacturing or using other means known to those of skill in the art.

The top frame (indicated at 350 below) positions superiorly to the bottom frame 100 from a forward perspective.

The frame, as shown, forms a half circle, but the frame may be circular, square, rectangular, polygonal, or irregularly-shaped.

FIG. 2 illustrates a rearward, side perspective view of a staggered arcuate frame 200 adapted for silicone edge graphics in accordance with the present invention.

The lower frame is shown in FIG. 2 is formed from components indicated at 202, 204, 206, 210, and 212 of which 204, 206, 210 and 212 are arcuate. The arcuate members 204, 206, 210 and 212 overlay the top frame 100, wherein both the top frame 100 and lower frame form arcs subtending at equal angles in some embodiments.

Each of the arcuate members 204, 206, 210 and 212 which overlay the top frame 100 are shorter in length and in arc length than overlaying superior members and are adapted such that each arcuate members 204, 206, 210 and 212 terminate at a midpoint of a member 104-108 of the top frame.

The lower frame 100 positions inferiorly to the top frame 100 from a forward perspective.

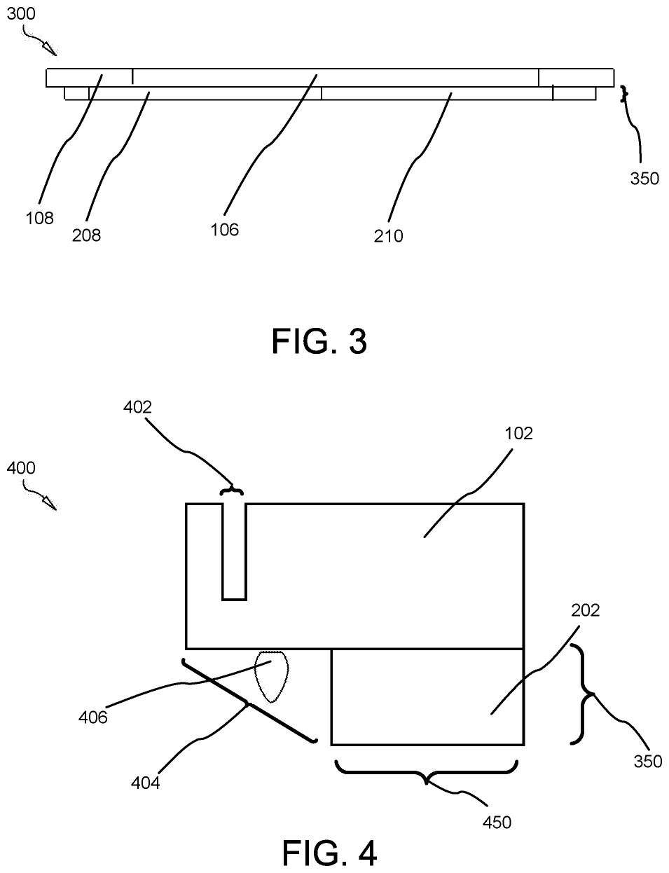

FIG. 3 illustrates a top perspective view of a staggered arcuate frame 300 adapted for silicone edge graphics in accordance with the present invention.

As shown, none of the arcuate members of the lower frame 100 conjoin with adjacent arcuate members of the lower frame 100 in the same spot as the arcuate members of the upper frame 350 conjoin with other arcuate members of the upper frame 350. In this respect, the arcuate members 104-108 are staggered against and below the arcuate members 204, 206, 210 and 212.

FIG. 4 illustrates a sectioned perspective view of a staggered arcuate frame 400 adapted for silicone edge graphics in accordance with the present invention.

A width 450 of the top frame 350 is less than the width of the lower frame 100 such that a lighting recess 404 forms between top edges of the top frame 350 and the lower frame 100. Lights 406, which may comprise light-emitting diodes (LEDs) are put to position within this lighting recess 404. A silicone edge graphic (SEG) disposes across this recess 404 which is backlit by the lights 406.

The outer channel 402 is recessed into the rearward surface of the lower frame 100 for receiving a peripheral edge of the SEG during mounting.

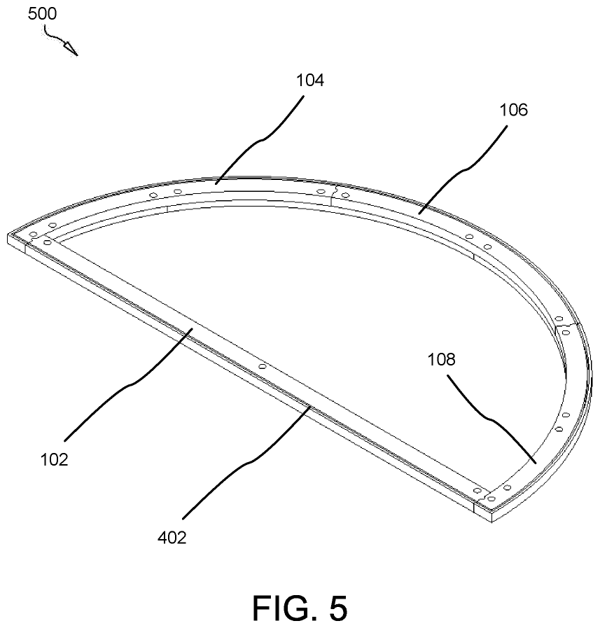

FIG. 5 illustrates a rearward, side perspective view of a staggered arcuate frame 500 adapted for silicone edge graphics in accordance with the present invention.

The frame, as shown, forms a half circle, but the frame may be circular, square, rectangular, polygonal, or irregularly-shaped.

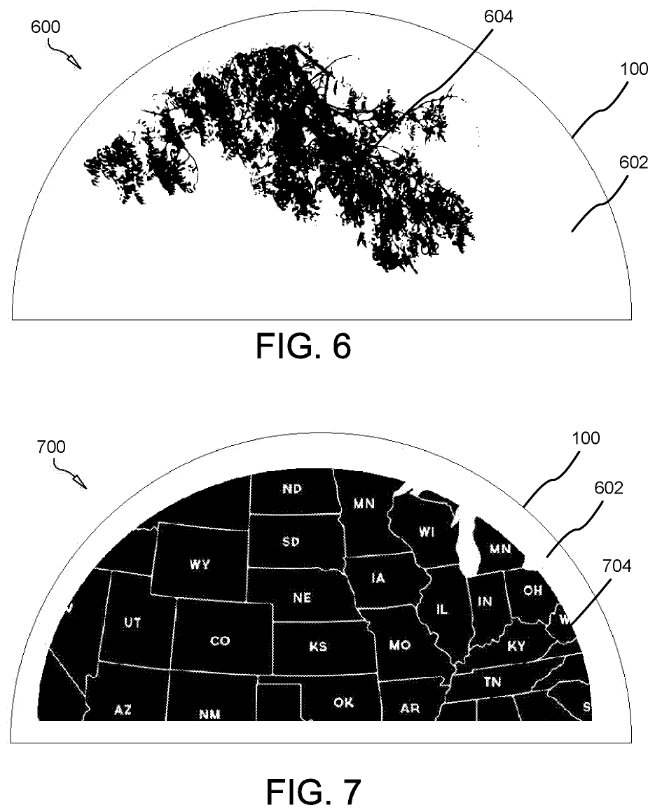

FIG. 6 illustrates a forward perspective view of a staggered arcuate frame 600 adapted with a silicone edge graphics in accordance with the present invention.

A SEG 604 is stretched across the top of the frame 200 depicting the graphic shown.

FIG. 7 illustrates a forward perspective view of a staggered arcuate frame 700 adapted with a silicone edge graphics in accordance with the present invention.

A SEG 704 is stretched across the top of the frame 200 depicting the graphic shown.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An interlocking frame for silicone edge graphics comprising:
a lower frame comprising:
a horizontal member having a planar bottom surface comprising two protuberances adapted to interlock with adjacent lower arcuate members, the horizontal member defining an outer channel for receiving a peripheral edge of a silicone edge graphic;
a first arcuate member defining a recess on a concave surface adapted to interlock with an adjacent protuberance on the horizontal member, the first arcuate member comprising a protuberance cantilevering from a terminal end adapted to interlock with an arcuate keystone member;
a second arcuate member defining a recess on a concave surface adapted to interlock with an adjacent protuberance on the horizontal member, the second arcuate member comprising a protuberance cantilevering from a terminal end adapted to interlock with an arcuate keystone member;
a keystone arcuate member defining a recess on a terminal end adapted to interlock with an adjacent protuberance on one of the first arcuate member and the second arcuate member, the keystone arcuate member comprising a protuberance cantilevering from a terminal end adapted to interlock with a lateral arcuate member;
wherein each of the first arcuate member, the second arcuate member and the keystone arcuate member define a pair of apertures extending longitudinally through from a top surface to a lower surface;
a top frame comprising:
a horizontal member having a planar bottom surface comprising two protuberances adapted to interlock with adjacent top arcuate members, the horizontal member defining an outer channel for receiving a peripheral edge of a silicone edge graphic;
three or more arcuate members defining a recess on a terminal end adapted to interlock with an adjacent protuberance on an adjacent arcuate member;
wherein two or more arcuate members comprise a protuberance cantilevering from a terminal end adapted to interlock with an adjacent member of the top frame;
wherein each of the top arcuate members define an aperture at a terminal end positioned to align with an aperture defined at an inferior midpoint on the lower frame.

2. (canceled)

3. The interlocking frame of claim 1, further comprises a plurality of light emitting diodes (LEDs) affixed to a top surface of the lower frame.

4. The interlocking frame of claim 1, wherein the lower frame arcuate members each define an outer channel for receiving the SEG.

5. An interlocking frame for silicone edge graphics comprising:
a lower frame comprising:
a horizontal member having a planar bottom surface comprising two protuberances adapted to interlock with adjacent lower arcuate members, the horizontal member defining an outer channel for receiving a peripheral edge of a silicone edge graphic;
a first arcuate member defining a recess on a concave surface adapted to interlock with an adjacent protuberance on the horizontal member, the first arcuate member comprising a protuberance cantilevering from a terminal end adapted to interlock with a lateral arcuate member;
a second arcuate member defining a recess on a concave surface adapted to interlock with an adjacent protuberance on the horizontal member, the second arcuate member comprising a protuberance cantilevering from a terminal end adapted to interlock with an arcuate keystone member;
a keystone arcuate member defining a recess on a terminal end adapted to interlock with an adjacent protuberance on one of the first arcuate member and the second arcuate member, the keystone arcuate member comprising a protuberance cantilevering from a terminal end adapted to interlock with an arcuate keystone member;
wherein each of the first arcuate member, the second arcuate member and the keystone arcuate member define a pair of apertures extending longitudinally through from a top surface to a lower surface;
a top frame comprising:
a horizontal member having a planar bottom surface comprising two protuberances adapted to interlock with adjacent top arcuate members, the horizontal member defining an outer channel for receiving a peripheral edge of a silicone edge graphic;
three or more arcuate members defining a recess on a terminal end adapted to interlock with an adjacent protuberance on an adjacent arcuate member, each arcuate member comprising a protuberance cantilevering from a terminal end adapted to interlock with an adjacent member of the top frame;
wherein each of the top arcuate members define an aperture at a terminal end positioned to align with an aperture defined at an inferior midpoint on the lower frame;
wherein the lower frame arcuate members each define an outer channel for receiving the SEG.

6. (canceled)

7. The interlocking frame of claim 1, further comprises a plurality of light emitting diodes (LEDs) affixed to a top surface of the lower frame.

8. The interlocking frame of claim 1, wherein each member of the top frame and the lower frame is formed via CNC.

9. An interlocking frame for silicone edge graphics comprising:
a lower frame consisting of:
a horizontal member having a planar bottom surface comprising two protuberances adapted to interlock with adjacent lower arcuate members, the horizontal member defining an outer channel for receiving a peripheral edge of a silicone edge graphic;
a first arcuate member defining a recess on a concave surface adapted to interlock with an adjacent protuberance on the horizontal member, the first arcuate member comprising a protuberance cantilevering from a terminal end adapted to interlock with a lateral arcuate member;
a second arcuate member defining a recess on a concave surface adapted to interlock with an adjacent protuberance on the horizontal member, the second arcuate member comprising a protuberance cantilevering from a terminal end adapted to interlock with an arcuate keystone member;
a keystone arcuate member defining a recess on a terminal end adapted to interlock with an adjacent protuberance on one of the first arcuate member and the second arcuate member, the keystone arcuate member comprising a protuberance cantilevering from a terminal end adapted to interlock with an arcuate keystone member;
wherein each of the first arcuate member, the second arcuate member and the keystone arcuate member define a pair of apertures extending longitudinally through from a top surface to a lower surface;
a top frame comprising:
a horizontal member having a planar bottom surface comprising two protuberances adapted to interlock with adjacent top arcuate members, the horizontal member defining an outer channel for receiving a peripheral edge of a silicone edge graphic;
three or more arcuate members defining a recess on a terminal end adapted to interlock with an adjacent protuberance on an adjacent arcuate member;
wherein one or more arcuate member comprises a protuberance cantilevering from a terminal end adapted to interlock with an adjacent member of the top frame;
wherein each of the top arcuate members define an aperture at a terminal end positioned to align with an aperture defined at an inferior midpoint on the lower frame.
